SEQUENCE LISTING (14 sequences)

SEQ ID NO: 1 - DNA, 72 bp, Artificial Sequence
  synthetic oligonucleotide
aaggagaggaggtaatacgactcactatagggagagcctccctcgcgccatcagbdhvbdtagaatgtggat

SEQ ID NO: 2 - DNA, 63 bp, Artificial Sequence
  synthetic oligonucleotide
cacattctactgagcgggctggcaaggctctccctttagtgagggttaattcctcctctcctt

SEQ ID NO: 3 - DNA, 72 bp, Artificial Sequence
  synthetic oligonucleotide
atccacattctahvbdhvctgatggcgcgagggaggctctccctatagtgagtcgtattacctcctctcctt

SEQ ID NO: 4 - DNA, 63 bp, Artificial Sequence
  synthetic oligonucleotide
aaggagaggaggaattaaccctcactaaagggagagccttgccagcccgctcagtagaatgtg

SEQ ID NO: 5 - DNA, 19 bp, Artificial Sequence
  synthetic oligonucleotide
gcctccctcgcgccatcag

SEQ ID NO: 6 - DNA, 19 bp, Artificial Sequence
  synthetic oligonucleotide
gccttgccagcccgctcag

SEQ ID NO: 7 - DNA, 12 bp, Artificial Sequence
  synthetic oligonucleotide
atgcacattcta

SEQ ID NO: 8 - DNA, 30 bp, Artificial Sequence
  synthetic oligonucleotide
ctgagtcggagacacgcagggatgagatgg

SEQ ID NO: 9 - DNA, 39 bp, Artificial Sequence
  synthetic oligonucleotide
cctatcccctgtgtgccttggcagtctcagtagaatgtg

SEQ ID NO: 10 - DNA, 12 bp, Artificial Sequence
  synthetic oligonucleotide
tagaatgtgcat

SEQ ID NO: 11 - DNA, 30 bp, Artificial Sequence
  synthetic oligonucleotide
ccatctcatccctgcgtgtctccgactcag

SEQ ID NO: 12 - DNA, 39 bp, Artificial Sequence
  synthetic oligonucleotide
cacattctactgagactgccaaggcacacaggggatagg

SEQ ID NO: 13 - DNA, 30 bp, Artificial Sequence; identical to SEQ ID NO: 11
  synthetic oligonucleotide

SEQ ID NO: 14 - DNA, 30 bp, Artificial Sequence
  synthetic oligonucleotide
cctatcccctgtgtgccttggcagtctcag

(19) United States
(12) Patent Application Publication
(10) Pub. No.: US 2013/0053253 A1
(43) Pub. Date: Feb. 28, 2013

(54) Region of Interest Extraction and Normalization Methods

(71) Applicants: Robert Osborne, Great Chesterford (GB); Andrew Slatter, London (GB)

(72) Inventors: Robert Osborne, Great Chesterford (GB); Andrew Slatter, London (GB)

(73) Assignee: Population Genetics Technologies Ltd, Cambridge (GB)

(21) Appl. No.: 13/521,426

(22) PCT Filed: Feb. 14, 2011
(86) PCT No.: PCT/IB2011/000573

§ 371 Date: Aug. 30, 2012

Related U.S. Application Data
(60) Provisional application No. 61/306,816, filed on Feb. 22, 2010.

(51) Int. Cl. C40B 50/06; C40B 20/00

(52) U.S. Cl. 506/2; 506/26

(57) ABSTRACT

Aspects of the present invention are drawn to methods and compositions for the genetic analysis of regions of interest from one or more starting polynucleotide sample, e.g., a multiplexed polynucleotide sample. In certain aspects, a polynucleotide sample comprising one or more region of interest (ROI) is subjected to independent amplification reactions for specific sub-regions within the ROI(s). The amount/concentration of the product from each sub-region amplification reaction is determined followed by producing a normalized sample based on the determined amount/concentration that is suitable for further analyses (e.g., sequencing).

A major goal in genetics research is to understand the genetic underpinning for complex traits, particularly susceptibilities for common diseases such as diabetes, cancer, hypertension, and the like, e.g. Collins et al, Nature, 422: 835-847 (2003). The draft sequence of the human genome has provided a starting point for this highly complex endeavor. The development of high throughput and/or region-specific genetic analyses will play a key role in facilitating our understanding of how genetics determine or affect states of health and disease.

### SUMMARY

Aspects of the present invention are drawn to methods and compositions for the genetic analysis of regions of interest from one or more starting polynucleotide sample(s), e.g., a multiplexed polynucleotide sample. In certain aspects, a polynucleotide sample comprising one or more region of interest (ROI) is subjected to independent amplification reactions for specific sub-regions within the ROI(s). The amount/concentration of the product from each sub-region amplification reaction is determined followed by producing a normalized sample based on the determined amount/concentration that is suitable for further analyses (e.g., sequencing).

### BRIEF DESCRIPTION OF THE DRAWINGS

The invention is best understood from the following detailed description when read in conjunction with the accompanying drawings. It is emphasized that, according to common practice, the various features of the drawings are not to-scale. Indeed, the dimensions of the various features are arbitrarily expanded or reduced for clarity. Included in the drawings are the following figures:

FIG. 1 shows biochemical steps employed to isolate ROIs and then conduct independent amplifications on such isolated ROIs.

FIG. 2 describes an alternative method for performing the isolation of ROIs which employs the use of two specific probes and subsequent displacement from a solid support using a strand-displacing nucleic acid polymerase.

FIG. 3 is a flowchart which shows the steps involved in isolating the ROIs, performing the independent amplification reactions on the pool of isolated ROIs, determining the concentration of desired products of the respective amplification reactions, and then combining together the products in desired proportions (i.e., normalizing) using the measurements made.

FIGS. 4A, 4B, 4C, and 4D provide data showing the advantages of the ROI extraction and normalization processes described in FIG. 3.

### DEFINITIONS

Unless otherwise defined, all technical and scientific terms used herein have the same meaning as commonly understood by one of ordinary skill in the art to which this invention belongs. Still, certain elements are defined for the sake of clarity and ease of reference. Terms and symbols of nucleic acid chemistry, biochemistry, genetics, and molecular biology used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Eckstein, editor, Oligonucleotides and Analogs: A Practical Approach (Oxford University Press, New York, 1991); Gait, editor, Oligonucleotide Synthesis: A Practical Approach (IRL Press, Oxford, 1984); and the like.

“Amplicon” means the product of a polynucleotide amplification reaction. That is, it is a population of polynucleotides, usually double stranded, that are replicated from one or more starting sequences. The one or more starting sequences may be one or more copies of the same sequence, or it may be a mixture of different sequences. Amplicons may be produced by a variety of amplification reactions whose products are multiple replicates of one or more target polynucleotides. Generally, amplification reactions producing amplicons are “template-driven” in that base pairing of reactants, either nucleotides or oligonucleotides, have complements in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. Pat. Nos. 4,683,195; 4,965,188; 4,683,202; 4,800,159 (PCR); Gelfand et al, U.S. Pat. No. 5,210,015 (real-time PCR with “TAQMAN™” probes); Wittwer et al, U.S. Pat. No. 6,174,670; Kacian et al, U.S. Pat. No. 5,399,491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. An amplification reaction may be a “real-time” amplification if a detection chemistry is available that permits a reaction product to be measured as the amplification reaction progresses, e.g. “real-time PCR” described below, or “real-time NASBA” as described in Leone et al, Nucleic Acids Research, 26: 2150-2155 (1998), and like references. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like.

The term “assessing” includes any form of measurement, and includes determining if an element is present or not. The terms “determining”, “measuring”, “evaluating”, “assessing” and “assaying” are used interchangeably and includes quantitative and qualitative determinations. Assessing may be relative or absolute. “Assessing the presence of” includes determining the amount of something present, and/or determining whether it is present or absent. As used herein, the terms “determining,” “measuring,” and “assessing,” and “assaying” are used interchangeably and include both quantitative and qualitative determinations.

“Complementary” or “substantially complementary” refers to the hybridization or base pairing or the formation of a duplex between nucleotides or polynucleotides, such as, for instance, between the two strands of a double stranded DNA molecule or between an oligonucleotide primer and a primer binding site on a single stranded polynucleotide. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

“Duplex” means at least two oligonucleotides and/or polynucleotides that are fully or partially complementary undergo Watson-Crick type base pairing among all or most of their nucleotides so that a stable complex is formed. The terms “annealing” and “hybridization” are used interchangeably to mean the formation of a stable duplex. “Perfectly matched” in reference to a duplex means that the poly- or oligonucleotide strands making up the duplex form a double stranded structure with one another such that every nucleotide in each strand undergoes Watson-Crick base pairing with a nucleotide in the other strand. A stable duplex can include Watson-Crick base pairing and/or non-Watson-Crick base pairing (e.g., Hoogsteen base pairs) between the strands of the duplex (where base pairing means the forming hydrogen bonds). In certain embodiments, a non-Watson-Crick base pair includes a nucleoside analog, such as deoxyinosine, 2,6-diaminopurine, PNAs, LNA's and the like. In certain embodiments, a non-Watson-Crick base pair includes a “wobble base”, such as deoxyinosine, 8-oxo-dA, 8-oxo-dG and the like, where by “wobble base” is meant a nucleic acid base that can base pair with a first nucleotide base in a complementary polynucleotide strand but that, when employed as a template strand for polynucleotide synthesis, leads to the incorporation of a second, different nucleotide base into the synthesizing strand (wobble bases are described in further detail below). A “mismatch” in a duplex between two oligonucleotides or polynucleotides means that a pair of nucleotides in the duplex fails to undergo Watson-Crick bonding.

“Genetic region,” “region,” “region of interest,” (ROI) and equivalents in reference to a genome or target polynucleotide, means a sub-region or segment of the genome or target polynucleotide. As used herein, genetic region, region, or region of interest (ROI) may refer to the position of a nucleotide, a gene or a portion of a gene in a genome, including mitochondrial DNA or other non-chromosomal DNA (e.g., bacterial plasmid), or it may refer to any contiguous portion of genomic sequence whether or not it is within, or associated with, a gene. A genetic region, region, or region of interest (ROI) can be from a single nucleotide to a segment of a few hundred or a few thousand nucleotides in length or more.

By “isolation”, “isolate”, “isolating” and the like is meant selecting or separating one or more constituents from others in a sample. “Isolating” thus includes producing a sample that has an increased percentage of one or more constituents of interest from a starting sample (e.g., by positive or negative selection). An isolated sample may contain the constituent(s) of interest at anywhere from 1% or more, 5% or more, 10% or more, 50% or more, 75% or more, 90% or more, 95% or more, 99% or more, and up to and including 100% purity. The terms “enriching”, “purifying”, “separating”, “selecting” and the like, are used interchangeably with “isolating”.

“Kit” refers to any delivery system for delivering materials or reagents for carrying out a method of the invention. In the context of reaction assays, such delivery systems include systems that allow for the storage, transport, or delivery of reaction reagents (e.g., probes, enzymes, etc. in the appropriate containers) and/or supporting materials (e.g., buffers, written instructions for performing the assay etc.) from one location to another. For example, kits include one or more enclosures (e.g., boxes) containing the relevant reaction reagents and/or supporting materials. Such contents may be delivered to the intended recipient together or separately. For example, a first container may contain an enzyme for use in an assay, while a second container contains probes.

“Ligation” means to form a covalent bond or linkage between the termini of two or more nucleic acids, e.g. oligonucleotides and/or polynucleotides, in a template-driven reaction. The nature of the bond or linkage may vary widely and the ligation may be carried out enzymatically or chemically. As used herein, ligations are usually carried out enzymatically to form a phosphodiester linkage between a 5′ carbon of a terminal nucleotide of one oligonucleotide with 3′ carbon of another oligonucleotide. A variety of template-driven ligation reactions are described in the following references, which are incorporated by reference: Whiteley et al, U.S. Pat. No. 4,883,750; Letsinger et al, U.S. Pat. No. 5,476,930; Fung et al, U.S. Pat. No. 5,593,826; Kool, U.S. Pat. No. 5,426,180; Landegren et al, U.S. Pat. No. 5,871,921; Xu and Kool, Nucleic Acids Research, 27: 875-881 (1999); Higgins et al, Methods in Enzymology, 68: 50-71 (1979); Engler et al, The Enzymes, 15: 3-29 (1982); and Namsaraev, U.S. patent publication 2004/0110213.

“Multiplex Identifier” (MID) is used herein refers to a tag or combination of tags associated with a polynucleotide whose identity (e.g., sequence) can be used to differentiate polynucleotides in a sample. In certain embodiments, the MID on a polynucleotide is used to identify the source from which the polynucleotide is derived. For example, a nucleic acid sample may be a pool of polynucleotides derived from different sources, (e.g., polynucleotides derived from different individuals, different tissues or cells, or polynucleotides isolated at different times points), where the polynucleotides from each different source is tagged with a unique MID. As such, a MID provides a correlation between a polynucleotide and its source. In certain embodiments, MIDs are employed to uniquely tag each individual polynucleotide in a sample. Identification of the number of unique MIDs in a sample can provide a readout of how many individual polynucleotides are present in the sample (or from how many original polynucleotides a manipulated polynucleotide sample was derived; see, e.g., U.S. Pat. No. 7,537,897, issued on May 26, 2009, incorporated herein by reference in its entirety). MIDs can range in length from 2 to 100 nucleotide bases or more and may include multiple subunits, where each different MID has a distinct identity and/or order of subunits. Exemplary nucleic acid tags that find use as MIDs are described in U.S. Pat. No. 7,544,473, issued on Jun. 6, 2009, and titled “Nucleic Acid Analysis Using Sequence Tokens”, as well as U.S. Pat. No. 7,393,665, issued on Jul. 1, 2008, and titled “Methods and Compositions for Tagging and Identifying Polynucleotides”, both of which are incorporated herein by reference in their entirety for their description of nucleic acid tags and their use in identifying polynucleotides.

“Nucleoside” as used herein includes the natural nucleosides, including 2′-deoxy and 2′-hydroxyl forms, e.g. as described in Kornberg and Baker, DNA Replication, 2nd Ed. (Freeman, San Francisco, 1992). “Analogs” in reference to nucleosides includes synthetic nucleosides having modified base moieties and/or modified sugar moieties, e.g. described by Scheit, Nucleotide Analogs (John Wiley, New York, 1980); Uhlman and Peyman, Chemical Reviews, 90: 543-584 (1990), or the like, with the proviso that they are capable of specific hybridization. Such analogs include synthetic nucleosides designed to enhance binding properties, reduce complexity, increase specificity, and the like. Polynucleotides comprising analogs with enhanced hybridization or nuclease resistance properties are described in Uhlman and Peyman (cited above); Crooke et al, Exp. Opin. Ther. Patents, 6: 855-870 (1996); Mesmaeker et al, Current Opinion in Structual Biology, 5: 343-355 (1995); and the like. Exemplary types of polynucleotides that are capable of enhancing duplex stability include oligonucleotide N3′→P5′ phosphoramidates (referred to herein as “amidates”), peptide nucleic acids (referred to herein as “PNAs”), oligo-2′-O-alkylribonucleotides, polynucleotides containing C-5 propynylpyrimidines, locked nucleic acids (“LNAs”), and like compounds. Such oligonucleotides are either available commercially or may be synthesized using methods described in the literature.

“Polymerase chain reaction,” or “PCR,” means a reaction for the in vitro amplification of specific DNA sequences by the simultaneous primer extension of complementary strands of DNA. In other words, PCR is a reaction for making multiple copies or replicates of a target polynucleotide flanked by primer binding sites, such reaction comprising one or more repetitions of the following steps: (i) denaturing the target polynucleotide, (ii) annealing primers to the primer binding sites, and (iii) extending the primers by a nucleic acid polymerase in the presence of nucleoside triphosphates. Usually, the reaction is cycled through different temperatures optimized for each step in a thermal cycler instrument. Particular temperatures, durations at each step, and rates of change between steps depend on many factors well-known to those of ordinary skill in the art, e.g. exemplified by the references: McPherson et al, editors, PCR: A Practical Approach and PCR2: A Practical Approach (IRL Press, Oxford, 1991 and 1995, respectively). For example, in a conventional PCR using Taq DNA polymerase, a double stranded target polynucleotide may be denatured at a temperature >90° C., primers annealed at a temperature in the range 50-75° C., and primers extended at a temperature in the range 72-78° C. The term “PCR” encompasses derivative forms of the reaction, including but not limited to, RT-PCR, real-time PCR, nested PCR, quantitative PCR, multiplexed PCR, and the like. Reaction volumes typically range from a few hundred nanoliters, e.g. 200 mL, to a few hundred μL, e.g. 200 μL. “Reverse transcription PCR,” or “RT-PCR,” means a PCR that is preceded by a reverse transcription reaction that converts a target RNA to a complementary single stranded DNA, which is then amplified, e.g. Tecott et al, U.S. Pat. No. 5,168,038, which patent is incorporated herein by reference. “Real-time PCR” means a PCR for which the amount of reaction product, i.e. amplicon, is monitored as the reaction proceeds. There are many forms of real-time PCR that differ mainly in the detection chemistries used for monitoring the reaction product, e.g., Gelfand et al, U.S. Pat. No. 5,210,015 (“TAQMAN™”); Wittwer et al, U.S. Pat. Nos. 6,174,670 and 6,569,627 (intercalating dyes); Tyagi et al, U.S. Pat. No. 5,925,517 (molecular beacons); which patents are incorporated herein by reference. Detection chemistries for real-time PCR are reviewed in Mackay et al, Nucleic Acids Research, 30: 1292-1305 (2002), which is also incorporated herein by reference. “Nested PCR” means a two-stage PCR wherein the amplicon of a first PCR becomes the sample for a second PCR using a new set of primers, at least one of which binds to an interior location of the first amplicon. As used herein, “initial primers” in reference to a nested amplification reaction mean the primers used to generate a first amplicon, and “secondary primers” mean the one or more primers used to generate a second, or nested, amplicon. “Multiplexed PCR” means a PCR wherein multiple target sequences (or a single target sequence and one or more reference sequences) are simultaneously carried out in the same reaction mixture, e.g. Bernard et al, Anal. Biochem., 273: 221-228 (1999)(two-color real-time PCR). Usually, distinct sets of primers are employed for each sequence being amplified.

“Quantitative PCR” means a PCR designed to measure the abundance of one or more specific target sequences in a sample or specimen. Quantitative PCR includes both absolute quantitation and relative quantitation of such target sequences. Quantitative measurements are made using one or more reference sequences that may be assayed separately or together with a target sequence. The reference sequence may be endogenous or exogenous to a sample or specimen, and in the latter case, may comprise one or more competitor templates. Typical endogenous reference sequences include segments of transcripts of the following genes: β-actin, GAPDH, β₂-microglobulin, ribosomal RNA, and the like. Techniques for quantitative PCR are well-known to those of ordinary skill in the art, as exemplified in the following references that are incorporated by reference: Freeman et al, Biotechniques, 26: 112-126 (1999); Becker-Andre et al, Nucleic Acids Research, 17: 9437-9447 (1989); Zimmerman et al, Biotechniques, 21: 268-279 (1996); Diviacco et al, Gene, 122: 3013-3020 (1992); Becker-Andre et al, Nucleic Acids Research, 17: 9437-9446 (1989); and the like.

“Polynucleotide” or “oligonucleotide” is used interchangeably and each means a linear polymer of nucleotide monomers. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, wobble base pairing, or the like. As described in detail below, by “wobble base” is meant a nucleic acid base that can base pair with a first nucleotide base in a complementary polynucleotide strand but that, when employed as a template strand for nucleic acid synthesis, leads to the incorporation of a second, different nucleotide base into the synthesizing strand. Such monomers and their internucleosidic linkages may be naturally occurring or may be analogs thereof, e.g. naturally occurring or non-naturally occurring analogs. Non-naturally occurring analogs may include peptide nucleic acids (PNAs, e.g., as described in U.S. Pat. No. 5,539,082, incorporated herein by reference), locked nucleic acids (LNAs, e.g., as described in U.S. Pat. No. 6,670,461, incorporated herein by reference), phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moieties, or bases at any or some positions. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process is determined by the sequence of the template polynucleotide. Usually primers are extended by a DNA polymerase. Primers are generally of a length compatible with its use in synthesis of primer extension products, and are usually are in the range of between 8 to 100 nucleotides in length, such as 10 to 75, 15 to 60, 15 to 40, 18 to 30, 20 to 40, 21 to 50, 22 to 45, 25 to 40, and so on, more typically in the range of between 18-40, 20-35, 21-30 nucleotides long, and any length between the stated ranges. Typical primers can be in the range of between 10-50 nucleotides long, such as 15-45, 18-40, 20-30, 21-25 and so on, and any length between the stated ranges. In some embodiments, the primers are usually not more than about 10, 12, 15, 20, 21, 22, 23, 24, 25, 26, 27, 28, 29, 30, 35, 40, 45, 50, 55, 60, 65, or 70 nucleotides in length.

Primers are usually single-stranded for maximum efficiency in amplification, but may alternatively be double-stranded. If double-stranded, the primer is usually first treated to separate its strands before being used to prepare extension products. This denaturation step is typically affected by heat, but may alternatively be carried out using alkali, followed by neutralization. Thus, a “primer” is complementary to a template, and complexes by hydrogen bonding or hybridization with the template to give a primer/template complex for initiation of synthesis by a polymerase, which is extended by the addition of covalently bonded bases linked at its 3′ end complementary to the template in the process of DNA synthesis.

A “primer pair” as used herein refers to first and second primers having nucleic acid sequence suitable for nucleic acid-based amplification of a target polynucleotide or region thereof. Such primer pairs generally include a first primer having a sequence that is the same or similar to that of a first portion of a target polynucleotide, and a second primer having a sequence that is complementary to a second portion of a target polynucleotide to provide for amplification of the target polynucleotide or a region thereof. Reference to “first” and “second” primers herein is arbitrary, unless specifically indicated otherwise. For example, the first primer can be designed as a “forward primer” (which initiates nucleic acid synthesis from a 5′ end of the target nucleic acid) or as a “reverse primer” (which initiates nucleic acid synthesis from a 5′ end of the extension product produced from synthesis initiated from the forward primer). Likewise, the second primer can be designed as a forward primer or a reverse primer.

“Readout” means a parameter, or parameters, which are measured and/or detected that can be converted to a number or value. In some contexts, readout may refer to an actual numerical representation of such collected or recorded data. For example, a readout of fluorescent intensity signals from a microarray is the address and fluorescence intensity of a signal being generated at each hybridization site of the microarray; thus, such a readout may be registered or stored in various ways, for example, as an image of the microarray, as a table of numbers, or the like.

“Reflex site”, “reflex sequence” and equivalents are used to indicate one or more sequences present in a polynucleotide that are employed to move a domain intra-molecularly from its initial location to a different location in the polynucleotide. The use of reflex sequences is described in detail in U.S. provisional applications 61/235,595 and 61/288,792, filed on Aug. 20, 2009 and Dec. 21, 2009, respectively, and entitled “Compositions and Methods for Intramolecular Nucleic Acid Rearrangement Using Reflex Sequences”, incorporated herein by reference. In certain embodiments, a reflex sequence is chosen so as to be distinct from other sequences in the polynucleotide (i.e., with little sequence homology to other sequences likely to be present in the polynucleotide, e.g., genomic or sub-genomic sequences to be processed). As such, a reflex sequence should be selected so as to not hybridize to any sequence except its complement under the conditions employed in the reflex processes. The reflex sequence may be a synthetic or artificially generated sequence (e.g., added to a polynucleotide in an adapter domain) or a sequence present normally in a polynucleotide being assayed (e.g., a sequence present within a region of interest in a polynucleotide being assayed). In the reflex system, a complement to the reflex sequence is present (e.g., inserted in an adapter domain) on the same strand of the polynucleotide as the reflex sequence (e.g., the same strand of a double-stranded polynucleotide or on the same single stranded polynucleotide), where the complement is placed in a particular location so as to facilitate an intramolecular binding and polymerization event on such particular strand. Reflex sequences employed in the reflex process described herein can thus have a wide range of lengths and sequences. Reflex sequences may range from 5 to 200 nucleotide bases in length.

“Solid support”, “support”, and “solid phase support” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. Microarrays usually comprise at least one planar solid phase support, such as a glass microscope slide.

“Specific” or “specificity” in reference to the binding of one molecule to another molecule, such as a labeled target sequence for a probe, means the recognition, contact, and formation of a stable complex between the two molecules, together with substantially less recognition, contact, or complex formation of that molecule with other molecules. In one aspect, “specific” in reference to the binding of a first molecule to a second molecule means that to the extent the first molecule recognizes and forms a complex with another molecule in a reaction or sample, it forms the largest number of the complexes with the second molecule. Preferably, this largest number is at least fifty percent. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak noncovalent chemical interactions, such as Van der Waal forces, hydrogen bonding, base-stacking interactions, ionic and hydrophobic interactions, and the like, dominate the interaction of the molecules.

As used herein, the term “Tₘ” is used in reference to the “melting temperature.” The melting temperature is the temperature (e.g., as measured in ° C.) at which a population of double-stranded polynucleotide molecules becomes half dissociated into single strands. Several equations for calculating the Tₘ of nucleic acids are known in the art (see e.g., Anderson and Young, Quantitative Filter Hybridization, in Nucleic Acid Hybridization (1985). Other references (e.g., Allawi, H. T. & SantaLucia, J., Jr., Biochemistry 36, 10581-94 (1997)) include alternative methods of computation which take structural and environmental, as well as sequence characteristics into account for the calculation of Tₘ.

“Sample” means a quantity of material from a biological, environmental, medical, or patient source in which detection, measurement, or labeling of target nucleic acids is sought. On the one hand it is meant to include a specimen or culture (e.g., microbiological cultures). On the other hand, it is meant to include both biological and environmental samples. A sample may include a specimen of synthetic origin. Biological samples may be animal, including human, fluid, solid (e.g., stool) or tissue, as well as liquid and solid food and feed products and ingredients such as dairy items, vegetables, meat and meat by-products, and waste. Biological samples may include materials taken from a patient including, but not limited to cultures, blood, saliva, cerebral spinal fluid, pleural fluid, milk, lymph, sputum, semen, needle aspirates, and the like. Biological samples may be obtained from all of the various families of domestic animals, as well as feral or wild animals, including, but not limited to, such animals as ungulates, bear, fish, rodents, etc. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention.

The terms “upstream” and “downstream” in describing nucleic acid molecule orientation and/or polymerization are used herein as understood by one of skill in the art. As such, “downstream” generally means proceeding in the 5′ to 3′ direction, i.e., the direction in which a nucleotide polymerase normally extends a sequence, and “upstream” generally means the converse. For example, a first primer that hybridizes “upstream” of a second primer on the same target polynucleotide molecule is located on the 5′ side of the second primer (and thus nucleic acid polymerization from the first primer proceeds towards the second primer).

It is further noted that the claims may be drafted to exclude any optional element. As such; this statement is intended to serve as antecedent basis for use of such exclusive terminology as “solely”, “only” and the like in connection with the recitation of claim elements, or the use of a “negative” limitation.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

It is noted that as used herein and in the appended claims, the singular forms “a”, “an”, and “the” include plural referents unless the context clearly dictates otherwise. Thus, for example, reference to “a nucleic acid” includes a plurality of such nucleic acids and reference to “the compound” includes reference to one or more compounds and equivalents thereof known to those skilled in the art, and so forth.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, New York, Gait, “Oligonucleotide Synthesis: A Practical Approach” 1984, IRL Press, London, Nelson and Cox (2000), Lehninger, A., Principles of Biochemistry 3^{rd} Ed., W.H. Freeman Pub., New York, N.Y. and Berg et al. (2002) Biochemistry, 5^{th} Ed., W.H. Freeman Pub., New York, N.Y., all of which are herein incorporated in their entirety by reference for all purposes.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Polynucleotides and Polynucleotide Samples

The genetic analysis methods and compositions described herein can be employed for the analysis of polynucleotides from virtually any source, including but not limited to genomic DNA, complementary DNA (cDNA), RNA (e.g., messenger RNA, ribosomal RNA, short interfering RNA, microRNA, etc.), plasmid DNA, mitochondrial DNA, etc. Furthermore, as any organism can be used as a source of polynucleotides to be processed in accordance with the present invention, no limitation in that regard is intended. Exemplary organisms include, but are not limited to, plants, animals (e.g., reptiles, mammals, insects, worms, fish, etc.), bacteria, fungi (e.g., yeast), viruses, etc. In certain embodiments, the polynucleotides are derived from a mammal, where in certain embodiments the mammal is a human.

In certain embodiments, the polynucleotide sample being analyzed is derived from a single source (e.g., a single organism, virus, tissue, cell, subject, etc.), whereas in other embodiments, the polynucleotide sample is a pool of polynucleotides extracted from a plurality of sources (e.g., a pool of polynucleotides from a plurality of organisms, tissues, cells, subjects, etc.), where by “plurality” is meant two or more. As such, in certain embodiments, a polynucleotide sample can contain polynucleotides from 2 or more sources, 3 or more sources, 5 or more sources, 10 or more sources, 50 or more sources, 100 or more sources, 500 or more sources, 1000 or more sources, 5000 or more sources, up to and including about 10,000 or more sources. No limitation in this regard is intended.

In certain embodiments, the polynucleotides derived from each source include a multiplex identifier (MID) such that the source from which each tagged polynucleotide fragment was derived can be determined. In such embodiments, each polynucleotide sample source is correlated with a unique MID, where by unique MID is meant that each different MID employed can be differentiated from every other MID employed by virtue of at least one characteristic, e.g., the nucleic acid sequence of the MID. Any type of MID can be used, including but not limited to those described in co-pending U.S. patent application Ser. No. 11/656,746, filed on Jan. 22, 2007, and titled “Nucleic Acid Analysis Using Sequence Tokens”, as well as U.S. Pat. No. 7,393,665, issued on Jul. 1, 2008, and titled “Methods and Compositions for Tagging and Identifying Polynucleotides”, both of which are incorporated herein by reference in their entirety for their description of nucleic acid tags and their use in identifying tagged polynucleotides. In certain embodiments, a set of MIDs employed to tag a plurality of samples need not have any particular common property (e.g., Tₘ, length, base composition, etc.), as the methods described herein can accommodate a wide variety of unique MID sets.

In certain embodiments, each individual polynucleotide (e.g., double-stranded or single-stranded, as appropriate to the methodological details employed) in a sample to be analyzed is tagged with a unique MID so that the fate of each polynucleotide can be tracked in subsequent processes (where, as noted above, unique MID is meant to indicate that each different MID employed can be differentiated from every other MID employed by virtue of at least one characteristic, e.g., the nucleic acid sequence of the MID).

In certain embodiments, a polynucleotide sample is processed into an “immortalized” sample in the workflow of the subject invention. In general, an “immortalized” sample is a sample from which copies can be made without degrading the integrity of the original sample, akin to producing a “master copy” of a document from which photocopies can be made indefinitely. For example, an immortalized sample can be produced by immobilizing adapter-ligated fragments to a solid substrate, where the adapter includes a synthesis primer binding site. Such immobilized fragments can be used to produce copies of the fragments by primer extension using the adapter primer binding site. These copies can be eluted from the immobilized fragments for subsequent manipulation. The immobilized adapter ligated fragments can then be used to produce more copies.

In certain embodiments, an immortalized sample is a sample that allows an indefinite number of sequential copies to be produced. This is akin to making copies from previous copies, for example as in producing a copy of a copy of an original electronic file. For example, a sample of polynucleotide fragments that include PCR primer binding sites on both ends (e.g., present in adapter sequences ligated to the fragments) can be PCR amplified to produce a first copy of the fragments, the first copy can be PCR amplified to produce a second copy, etc. Other functional sites in adapter sequences on the terminal ends of nucleic acid fragments can also be used to produce immortalized samples (e.g., T3 and/or T7 RNA polymerase binding sites, e.g., where a T3 site is in an adapter on a first end of a polynucleotide fragment and a T7 site is in the adapter at the opposite end of the fragment; unique DNA polymerase binding sites; hairpin adaptors to create circular DNA that can be amplified by rolling circle amplification; or components of cellular replication systems, e.g. bacterial plasmids).

In certain embodiments, an adaptered sample includes functional elements that allow it to be immortalized both of the ways described above (i.e., such that the original adapter ligated sample can be copied indefinitely and such that the resultant copies can be copied sequentially). In addition, an immortalized library may be produced at any step, or at multiple different steps, during the workflow, e.g., directly from the polynucleotides derived from a particular source, after MID tagging, after production of a mixed polynucleotide sample (combining MID tagged polynucleotides from different sources), after an enrichment or isolation step (e.g., region of interest extraction, as detailed below), etc. In essence, the point at which to generate an immortalized sample is dependent on the desires of a user. For example, one could add a T7 promoter sequence to a polynucleotide of interest using a T7-tailed primer in an extension reaction at any point in the workflow.

Construction of polynucleotides having adapter domains (and their functional elements) may be achieved in any convenient manner. For example, adapters may be added to polynucleotides by ligation (e.g., ligating adapter polynucleotides directly to polynucleotides in a sample), by an amplification reaction (e.g., by amplifying polynucleotides with a synthesis primer that includes an adapter domain in a 5′ tail), or a combination of both.

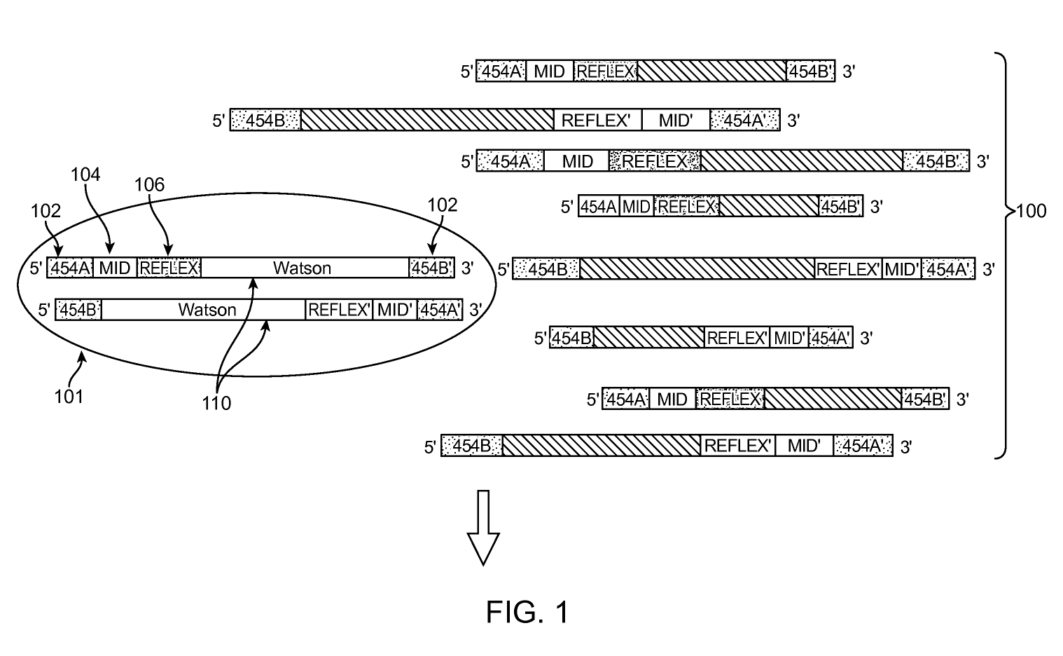

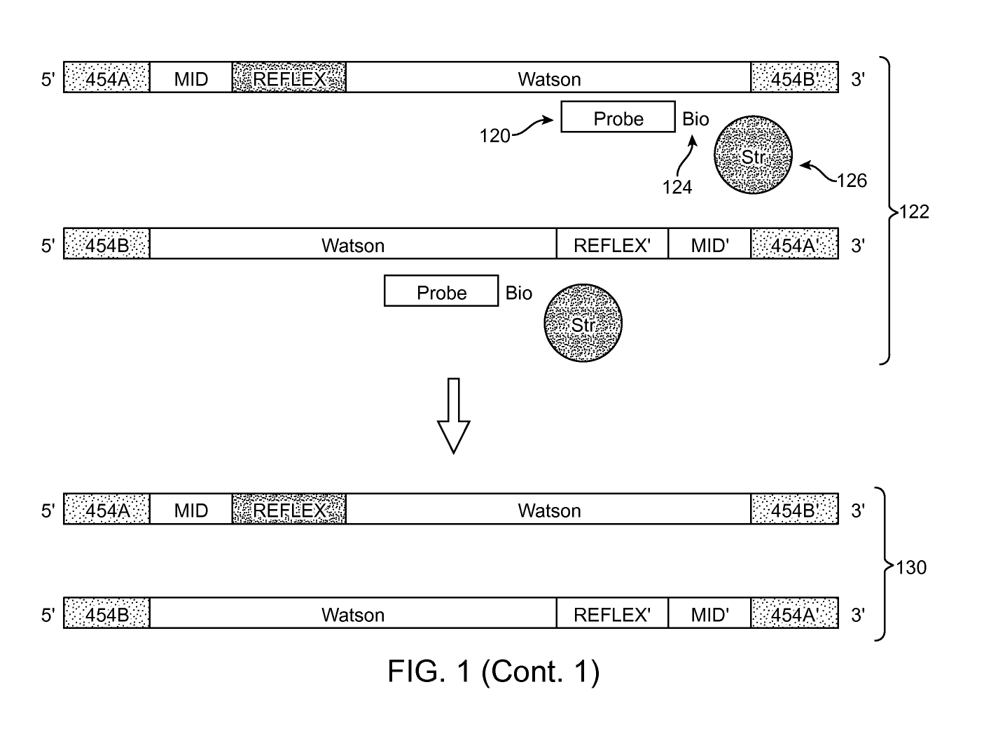

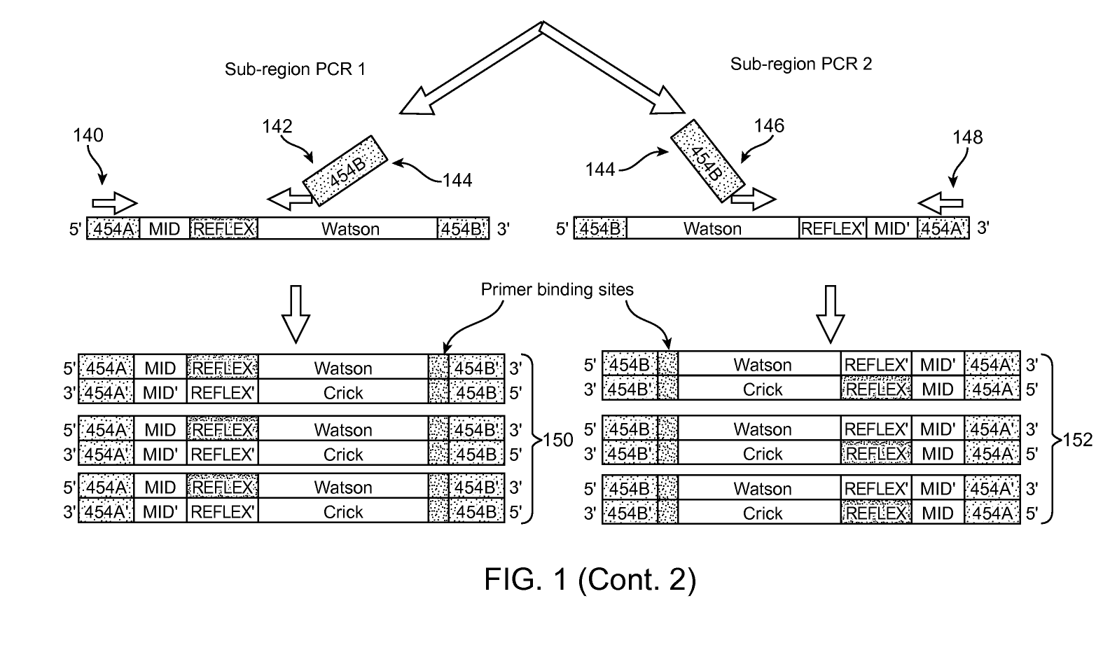

In certain embodiments, polynucleotides have asymmetric adapters (e.g., as shown in FIG. 1), meaning that the left and right adapter domains are not identical. Production of polynucleotides having asymmetric adapters may be achieved in any convenient manner. Exemplary asymmetric adapters are described in: U.S. Pat. Nos. 5,712,126 and 6,372,434; U.S. Patent Publications 2007/0128624 and 2007/0172839; and PCT publication WO/2009/032167; all of which are incorporated by reference herein in their entirety. In certain embodiments, the asymmetric adapters employed are those described in U.S. patent application Ser. No. 12/432,080, filed on Apr. 29, 2009, incorporated herein by reference in its entirety.

For example, the reflex sequence (or its complement) can be added at a particular position by linear amplification, PCR, ligation etc. For double stranded polynucleotides, an adapter can be configured to be ligated to a specific terminus, e.g., a specific restriction enzyme cut site, or a site of random cleavage using enzymes, nebulization, ultrasonic disruption, etc. In certain embodiments, the fragment ends can be “polished” to enable adapter ligation. The term “polished” (or equivalents) is used herein to mean a process for producing ends on a nucleic acid fragment (or fragments) that are suitable for ligation or attachment to another nucleic acid fragment (e.g., an adapter). As such, polishing refers to any step or steps used to produce ligation-compatible ends. Ligation-compatible ends may have any configuration, e.g., be blunt or have overhangs, also termed “sticky ends”, such terms being well known in the art. Ligation-compatible ends (e.g., of a fragment and an adapter) can be ligated to one another under appropriate ligation conditions, for example in the presence of an enzyme having DNA ligase activity in appropriate buffering conditions and co-factors. Where a single stranded polynucleotide is employed, a double stranded adapter construct that possesses an overhang configured to bind to the end of the single-stranded polynucleotide can be used. For example, in the latter case, the end of a single stranded polynucleotide can be modified to include specific nucleotide bases that are complementary to the overhang in the double stranded adaptor using terminal transferase and specific nucleotides. Again, any convenient method for producing a starting polynucleotide may be employed in practicing the methods of the subject invention.

### Region of Interest Extraction

While the description below describes enriched samples for use in aspects of the present invention, it is noted that the invention encompasses embodiments in which such enrichment (or region of interest extraction) is not performed.

In certain embodiments, polynucleotides from an initial sample (or multiple samples) are enriched for a subset of polynucleotides to produce one or more enriched samples. By “enriched” is meant that the polynucleotides are subjected to a process that reduces the complexity of the sample, generally by increasing the relative concentration of particular polynucleotide species in the sample (e.g., having a specific region of interest, including a specific polynucleotide sequence, lacking a region or sequence, being within a specific size range, etc.). In certain embodiments, enriching can include removing specific polynucleotides having an undesirable sequence or feature, e.g., polynucleotides that include frequently occurring repeat sequences. There are a wide variety of ways to enrich polynucleotides having a specific characteristic(s) or sequence, and as such any convenient method to accomplish this may be employed (see, e.g., Mamanova et al. 2010, Nature Methods vol. 7, pp. 111-118). The enrichment (or complexity reduction) can take place at any of a number of steps in the process, and will be determined by the desires of the user. For example, enrichment can take place in individual source-specific samples (e.g., untagged polynucleotides prior to adaptor ligation) or in multiplexed samples (e.g., polynucleotides tagged with MIDs and pooled).

Any convenient method for enriching (or isolating) polynucleotides from one or more samples having a region (or regions) of interest (ROI) may be used. For example, one or more species of polynucleotide fragment may be selected from a sample by hybridization to one or more capture moieties (e.g., capture oligonucleotides, capture polynucleotides or capture antibodies, e.g., antibodies specific for a transcription factor; etc.). In such embodiments, the sample is contacted to the capture moiety (or moieties) to form specific polynucleotide target/capture moiety complexes followed by isolation of these complexes from non-capture moiety bound polynucleotides. For example, where the capture moiety is bound to a solid phase substrate (e.g., a bead or array substrate), non-capture moiety bound polynucleotides can be removed by a washing step, after which the captured target polynucleotide fragments can be eluted (e.g., by denaturation). These isolated/selected polynucleotides can then be subjected to subsequent processing and analysis (e.g., tagging, amplification, sorting, etc.). See US Patent Application Publication 2006/0046251 for an exemplary description of ROI extraction using capture probes attached to a solid array support (incorporated herein by reference).

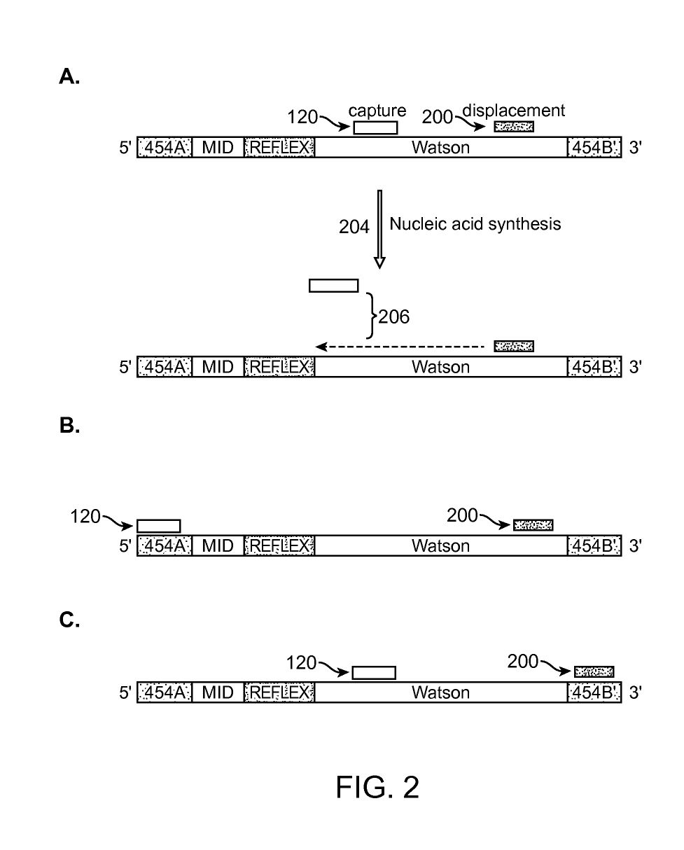

In certain embodiments, the polynucleotides selected have attached adapter(s) (e.g., as shown in FIG. 2, described below) prior to selection. Exemplary, non-limiting enrichment processes are described in U.S. Patent Application Publication 20060046251; U.S. Pat. No. 6,280,950; U.S. Pat. No. 7,217,522; U.S. Pat. No. 7,544,473; and PCT publication WO/2007/057652, all of which are incorporated by reference herein in their entirety.

The region of interest (ROI) of a polynucleotide can be any region for which analysis is desired, e.g., a genomic region, a region from an expression product (e.g., from an mRNA), a synthetically produced region, etc. In certain embodiments, an enriched sample contains a mixture of ROI-containing polynucleotides derived from multiple different sources. For example, the sample could be enriched for polynucleotides from different sources that each include a ROI corresponding to a specific gene or genomic region/locus (e.g., a specific exon of a gene). In certain other embodiments, an enriched sample may be a mixture of polynucleotides having multiple different ROIs (e.g., regions from multiple different genomic loci). As noted above, the number and identity of the one or more ROI in an enriched sample will be determined by the desires of the user, and as such, no limitation in this regard is intended. In embodiments in which polynucleotides in the starting sample are from multiple different sources, the polynucleotides can be tagged with a MID corresponding to their source, such that at any point in subsequent analysis or processing steps, determining the identity of the MID will correlate a polynucleotide with its source.

In the exemplary process shown in FIG. 1, a starting multiplexed polynucleotide sample 100 containing target polynucleotides 101 (i.e., polynucleotides comprising the region of interest (ROI) 110) is contacted under annealing conditions to a capture probe 120. (Note that the polynucleotides in the starting multiplexed polynucleotide sample 100 are shown in their single stranded form and in both asymmetric adapter orientations). In the exemplary process of FIG. 1, the polynucleotides in the multiplexed sample include adapter domains that contain sequencing primer binding sites (elements 102; in this case 454A and 454B sites used in the Roche 454 Sequencing Platform), an MID 104, and a Reflex sequence 106. The reflex sequence-finds use in performing intramolecular rearrangement to place a region of interest in proximity to a functional domain (e.g., a sequencing primer binding site) and is described in detail in U.S. provisional applications 61/235,595, and 61/288,792, filed on Aug. 20, 2009 and Dec. 21, 2009, respectively, and entitled “Compositions and Methods for Intramolecular Nucleic Acid Rearrangement Using Reflex Sequences”, incorporated herein by reference. Note that the prime designation (′) for a region in FIG. 1 denotes a sequence that is complementary to the region listed (e.g., 454B′ is complementary to 454B). The capture probe (or primer) 120 anneals specifically to a site present in the ROI in polynucleotides 101, but not to the other polynucleotides in the multiplexed sample. This sequence-specific annealing allows for the subsequent enrichment/isolation of polynucleotides having the ROI (as detailed below). It is noted here that while only two polynucleotides are shown in 101 (denoting two orientations of the asymmetric adapter domains), many more ROI-containing polynucleotides may be present in the sample. In addition, a polynucleotide sample may not contain polynucleotides with asymmetric adapters as shown.

In certain embodiments, more than one capture probe may be used in a single ROI enrichment step. The multiple capture probes may be specific for polynucleotides having the same ROI (e.g., capture probes that anneal to different sites in the same ROI and/or that anneal to both strands of an ROI) or for different ROIs present in different polynucleotides in the sample. For example, if a user wants to enrich for multiple different ROIs, one or more capture probes specific for the different ROIs can be employed in the annealing step. In certain embodiments, enrichment of multiple ROI, using multiple capture probes, is carried out in a single reaction (e.g., in a single tube). Alternatively, independent enrichment reactions can be performed for each ROI or capture probe.

As shown in FIG. 1, the annealing step results in the formation of capture-probe annealed polynucleotides containing the desired ROI 122 (note that only ROI-containing polynucleotides are shown here—polynucleotides 101 in the previous step). In certain embodiments, capture probes are functionalized in such a way as to allow the capture probe annealed polynucleotides to be isolated/enriched from non-capture probe annealed polynucleotides in the sample. Any suitable way for achieving this result can be employed.

In the example shown in FIG. 1, the capture probe 120 has an attached binding moiety 124 (in this case biotin; Bio) that enables isolation of capture probe annealed polynucleotides using the binding partner 126 of the binding moiety (in this case Streptavidin; Str). Binding moieties and their corresponding binding partners are also referred to herein as binding partner pairs. Any convenient binding partner pairs may be used, including but not limited to biotin/avidin (or streptavidin), antigen/antibody pairs, or any of a variety of other chemical and/or non-chemical binding partner pairs (e.g., using any combination of protein, nucleic acid, carbohydrate, lectin, and/or magnetic moieties, etc.).

In one example, after contacting the polynucleotide sample with a capture probe having an attached binding moiety under annealing conditions, the sample can be contacted to a solid phase surface (e.g., a bead, pin, column, plate, etc.) having the binding partner of the binding moiety attached thereto under suitable conditions for binding partner pair interaction. Polynucleotides that do not have an annealed capture probe (and thus lack the binding moiety) can then be removed/washed away from the solid phase surface, thus leaving capture probe annealed polynucleotides having the ROI on the substrate. Elution of these substrate-bound polynucleotides (e.g., by heat or alkaline denaturation from the capture probe) results in a sample enriched for polynucleotides with the ROI(s) (shown in FIG. 1 as polynucleotides 130). Thus, an enriched sample will have an increased representation of ROI-containing polynucleotides (shown in 130) over non-ROI-containing polynucleotides (not shown) as compared to the starting sample 100. It is noted that while only two polynucleotides are shown in 130, many more ROI-containing polynucleotides may be present in the enriched sample (similar to population 122 in FIG. 1).

As noted above, any suitable method for isolating/enriching for capture probe-bound polynucleotides can be used.

In certain embodiments, the capture probe is attached directly to a solid-phase surface, thus obviating the need for binding moiety/binding partners. For example, one or more capture probes may be attached to a bead or array prior to contact with the polynucleotide sample. As another example, a “bridging” oligo may be employed, where the bridging oligo binds simultaneously to a sequence at one end of the polynucleotide fragment of interest and a capture probe attached to a substrate (e.g., a bead or array substrate). In certain of these embodiments, a bridging oligonucleotide brings a target polynucleotide fragment and capture probe into proximity such that, under appropriate reaction conditions, the target polynucleotide fragment and capture probe are ligated to one another. In certain embodiments, this ligation stabilizes the binding of the bridging oligonucleotide to the target polynucleotide fragment. Further, bridging oligos can be designed to have relatively short regions of complementarity with the intended target fragments (e.g., less than 15 nucleotides) such that non-target polynucleotides that cross-hybridize with the bridging oligonucleotide but are unable to be ligated to the capture probe will not form stable hybridization complexes.

In certain other embodiments, target polynucleotides are isolated using a strand displacing nucleotide polymerase. For example, as shown in FIG. 2A, a displacement primer 200 can be annealed upstream of an annealed capture probe 120. These displacement primer/capture probe annealed polynucleotide duplexes can then be contacted with a nucleic acid polymerase having 5′ to 3′ strand displacement activity under nucleic acid synthesis conditions (step 204). Under these conditions, nucleic acid synthesis is initiated from the 3′ end of the displacement primer and proceeds to the capture probe annealing site. Because the nucleic acid polymerase employed has 5′ to 3′ strand displacement activity, any capture primer downstream of the displacement primer is displaced from the polynucleotide (206). Conversely, nucleic acid synthesis cannot be initiated by the nucleic acid polymerase if the displacement primer does not anneal to the polynucleotide upstream of the capture primer, thus providing specificity of displacement. In certain embodiments, the capture probe is not able to support nucleic acid synthesis (e.g., by including a terminal di-deoxynucleotide at its 3′ terminus). In certain embodiments (and as described above), the capture primer can have attached thereto a binding moiety or be attached to a solid phase surface.

In certain embodiments, the capture primer employed is immobilized on a solid phase support prior to the nucleic acid synthesis step. In these embodiments, polynucleotides in which nucleic acid synthesis is initiated from an annealed displacement primer are eluted from the solid support into the supernatant when the capture primer is displaced by the 5′ to 3′ displacement activity of the nucleic acid polymerase employed in the synthesis step 204. The capture primer may be attached to the solid phase support in any convenient manner, either covalently or non-covalently (e.g., using binding partner pairs, as described below).

As shown in FIG. 2B, alternative orientations of capture probe and displacement probe can be employed. For example, the capture probe may be directed to a site common to all polynucleotides in the sample (e.g., the 454A primer site, as shown) while the displacement primer is specific for a site in the ROI. By performing the nucleic acid synthesis reaction, only capture probes present on target polynucleotides (i.e, those having the ROI) will be displaced. Non-target polynucleotides can then be removed by virtue of their indirect physical association with the capture primer (polynucleotides containing the ROI no longer have annealed capture primers).

Alternatively, the capture probe may anneal within the ROI while the displacement primer anneals in a common region (e.g., the 454B site as shown in FIG. 2C). The site of annealing for the capture probe and the displacement primer will be determined by the desires of the user.

In certain other embodiments, the nucleic acid synthesis step is performed on capture primer annealed duplexes that are not immobilized on a solid phase surface (i.e., free in solution) followed by isolation of duplexes having annealed capture primers. In certain embodiments, the capture probe can serve as a synthesis primer in a nucleic acid synthesis reaction. In these embodiments, the extension reaction includes one or more deoxynucleotide triphosphates having an attached binding-moiety. In this embodiment, initiation of nucleic synthesis from the capture primer will lead to the incorporation of binding-moiety-containing bases, allowing isolation of polynucleotides having the region of interest using the binding partner of the binding moiety (e.g., attached to a substrate, e.g., a bead).

It is noted here that the steps of capture probe annealing, nucleic acid synthesis and solid phase support binding can be performed in any order that results in the isolation of polynucleotides having the ROI. The implementation of a ROI isolation step using the methods described above or variations thereof will generally be based on the desires of the user.

In certain embodiments, a polynucleotide sample, e.g., a starting polynucleotide sample (e.g., non-enriched sample) or isolated polynucleotides in an enriched sample (i.e., enriched for a ROI), can be subjected to a “generic” amplification. By “generic amplification” reaction is meant that the amplification reaction is designed not to be specific for certain regions or sub-regions of the polynucleotides in the enriched sample. For example, a polynucleotide sample can be subjected to a linear or PCR amplification reaction that employs primers or primer pairs that anneal in the common adapter regions of the polynucleotides. For example, a PCR reaction can be performed that employs a forward primer that hybridizes to all or part of the 454A sequencing primer binding site and a reverse primer that hybridizes to all or part of the 454B sequencing primer binding site. The specific constituents and/or primer/primer pairs employed in this amplification reaction will depend on the desires of the user and the sequences present in the polynucleotides (e.g., primer binding sites present in the adapter regions). Any suitable amplification reaction may be employed, e.g., linear, non-linear, exponential, etc.

### Amplification of Sub-Region(s)

While the amplification of sub-regions as described below refers mainly to using an ROI-enriched sample as the template, it is noted here that sub-region amplification (or production) can be performed on a non-enriched sample. Sub-regions of interest from a non-enriched sample (e.g., a non-enriched multiplexed sample) may be generated in any convenient manner, e.g., as described below for ROI-enriched samples, e.g., using PCR, a reflex process, combinations thereof, etc.

After production of a sample of reduced complexity containing one or more ROI (as detailed above), at least two sub-regions within the ROI(s) are amplified in independent amplification reactions. The at least two sub-ROI can be derived from the same ROI (e.g., from a single polynucleotide containing the ROI), from different ROIs (e.g., from different ROI present on different polynucleotides), or a combination of both. In the exemplary embodiment shown in FIG. 1, two independent PCR amplification reactions are performed (sub-region PCR 1 and 2). In these independent reactions, a different sub-region from the same ROI is amplified. For sub-region PCR1, the primers employed include a forward primer (140) that primes in the 454A sequencing primer binding site and a reverse primer (142) that primes within the ROI. For sub-region PCR 2, the primers employed include a forward primer (146) that primes within the ROI and a reverse primer (148) that primes within the 454A sequencing primer binding site. In the embodiments shown in FIG. 1, ROI specific primers 142 and 146 include a 454B tail (144). The products of these independent amplification reactions (shown as polynucleotides 150 and 152) contain sequences derived from the polynucleotides in the enriched sample. In other words, the amplification products include sub-sequences from the ROI-containing polynucleotides in enriched sample 130. The amplification products are sometimes referred to as containing a “sub-ROI”.

In certain embodiments, and as shown in FIG. 1, the amplification products have adapter structures similar to the enriched parent polynucleotides (due to the site of priming and domain structure of the forward and reverse primers used in the amplification reaction). In other implementations, the adapter structure of the amplified polynucleotides is different from that of the parent. For example, one or more amplification primers in the reactions can include an adapter domain containing a third primer binding site (e.g., not 454A or B primer binding sites).

In certain embodiments, the independent PCR reactions performed are specific for sub-ROI from a single starting ROI, whereas in other embodiments, the independent PCR reactions performed are specific for sub-ROI derived from a plurality of different starting ROI. In certain embodiments, multiple independent PCR reactions may be performed that amplify the same or substantially the same sub-ROI. No limitation with regard to the starting ROI nor the specific sub-ROI amplified is intended.

Any number of independent PCR reactions may be performed to produce samples enriched for sub-ROI. In certain embodiments, the number of independent PCR reactions performed ranges from 2 to 10,000 and anywhere in between, including but not limited to from 5 to 5,000, from 20 to 2,000, from 100 to 1,000, and so on. No limitation in this regard is intended.

Any convenient method for performing amplification reactions to produce samples enriched for polynucleotides having a sub-ROI of interest can be used in practicing the subject invention. In certain embodiments, the nucleic acid polymerase employed in the amplification reaction is a polymerase that has proofreading capability (e.g., phi29 DNA Polymerase, Thermococcus litoralis DNA polymerase, Pyrococcus furiosus DNA polymerase, etc.). In certain other embodiments, non-proofreading polymerases are employed. In certain embodiments, the amplification reaction includes a reflex process as described above and in U.S. provisional applications 61/235,595 and 61/288,792, filed on Aug. 20, 2009 and Dec. 21, 2009, respectively, and entitled “Compositions and Methods for Intramolecular Nucleic Acid Rearrangement Using Reflex Sequences”, incorporated herein by reference. The reflex process produces amplicons useful for subsequent processing (e.g., that can be normalized prior to sequencing, as described below). The products from the amplification process may be derived from the same type of amplification reaction (e.g., all reflex products) or can be derived from different types of reactions (e.g., products from standard PCR reactions and Reflex reactions can present in the same normalized sample).

The individual amplification reactions may be employed in any of a variety of subsequent process steps and/or analyses. For example, in embodiments in which a multiplexed sample is being analyzed, each amplified sample can be processed to isolate (or enrich for) polynucleotides having a sequence variation (or mutation) as compared to a reference sequence/polynucleotide. Exemplary polynucleotide variant isolation processes can be found, for example, in the following US patent applications, all of which are incorporated herein by reference: 61/258,143 and 61/299,182, filed Nov. 4, 2009 and Jan. 28, 2010, respectively, and entitled “Base-by-base Mutation Screening”; and 61/180,583 filed May 22, 2009 and entitled “Sorting Asymmetrically Tagged Nucleic Acids by Selective Primer Extension”.

It is further noted that additional processing steps or analysis can be performed after ROI enrichment but before performing amplification reactions for sub-ROI as described above. Such additional processing or analysis steps performed on the enriched and/or amplified samples is up to the desires of the user.

### Producing a Normalized Sample

After the amplification reaction, and after any desired intermediate steps (e.g., variant polynucleotide isolation as noted above), the polynucleotides containing sub-ROI in each sample are analyzed to determine their concentration (or amount). This determination can be accomplished in any convenient manner. For example, the amplification reactions may be quantitative amplification reactions that provide quantity data for the products during the reaction (e.g., qPCR) by the use of a labeled PCR primer. Alternatively, the determination can be accomplished by quantitating amplification products by observing them by such exemplary methods as gel electrophoresis techniques, capillary electrophoresis techniques, microfluidic measurement systems, use of fluorescent dyes which quantify nucleic acid present, or by spectrophotometric analysis.

Upon determining the amount or concentration of each of the sub-ROI-containing polynucleotides, a normalized sample can be produced and employed in subsequent processing steps and/or analysis. By “normalized sample” is meant that the different species of sub-ROI-containing polynucleotides in the sample are present at known molar ratios; “normalized” is not limited to mean that the polynucleotide species are present at the same (or substantially the same) amount or concentration, although such embodiments are encompassed by this term. Thus, in certain embodiments, the products are mixed such that the concentration or amount of each specific sub-ROI-containing polynucleotide is substantially equivalent in the normalized sample, whereas in other embodiments, the products are mixed such that the concentration or amount of one or more specific sub-ROI-containing polynucleotide is less than one or more of other specific sub-ROI-containing polynucleotide in the sample. No limitation in this regard is intended.

### Exemplary Workflows

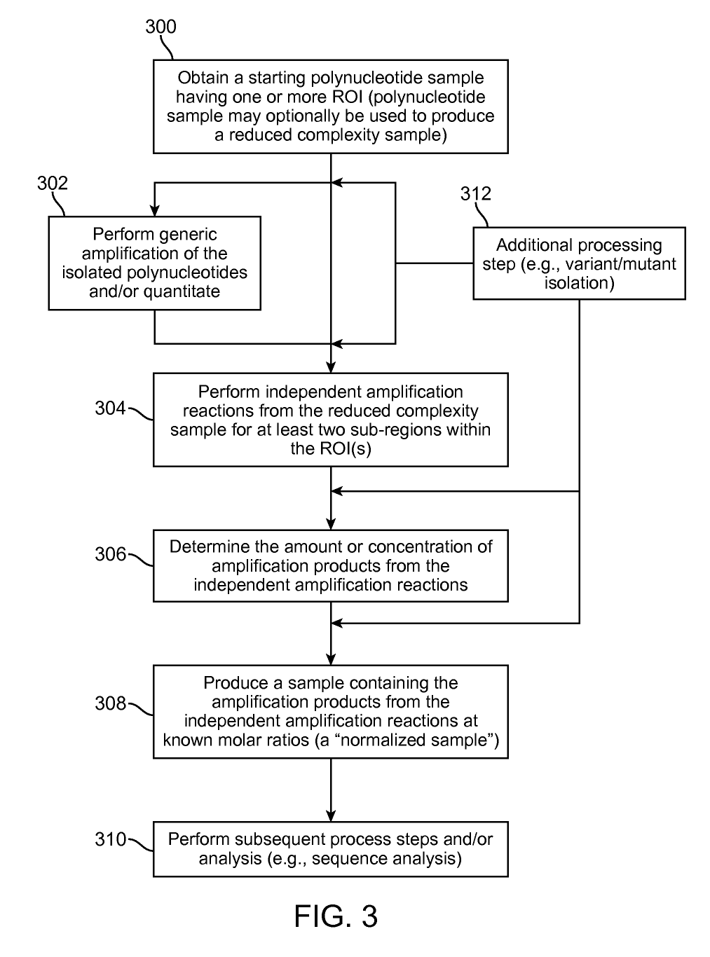

Below is provided exemplary descriptions of each of the steps in the workflow shown in FIG. 3. As is noted throughout, the workflow is meant to be exemplary and not limiting, as specific steps shown may be modified or deleted entirely. Also, additional steps not recited herein may be added. Variations to the workflow described herein will generally depend on the desires of the user.

In step 300, a starting polynucleotide sample is obtained having one or more ROI. As noted, the starting polynucleotide sample may optionally be used to produce a reduced complexity sample by enriching for (or isolating) polynucleotides that include the one or more ROI. In other words, the reduced complexity sample is enriched for polynucleotides that include one or more ROI as defined by a user. For example, a user can enrich for polynucleotides containing a single ROI or for polynucleotides containing any one of multiple different ROI (e.g., any one of two or more different ROI, any one of three or more different ROI, any one of five or more different ROI, any one of 10 or more different ROI, etc.). In addition, a user can enrich for polynucleotides that include, in the same polynucleotide, two or more different ROI. No limitation in this regard is intended.

In step 302, a user may perform a generic amplification reaction to increase the amount of enriched polynucleotides, e.g., by using a primers or primer pair that hybridize in adapter region(s) of the polynucleotides. Such generic amplifications may be performed at any of a variety of steps in the process, including before and/or after performing independent amplification reactions in step 304 (described below). Generic amplification reactions can be linear, non-linear or exponential, and will be dependent on the structure of the polynucleotides in the sample and the desires of the user. In certain embodiments, an enriched sample, whether it is generically amplified or not, can be quantitated prior to subsequent steps in the workflow.

In step 304, the polynucleotides in the enriched sample are used as a template for at least two different sub-ROI-specific amplification reactions, resulting in at least two samples containing amplified polynucleotides for the sub-ROI. The amount or concentration of the resultant amplification products from step 304 is determined in step 306 (e.g., by quantitation using any convenient method). A “normalized sample” is then produced in step 308 based on the determined amount/concentration of the amplification products. As described above, a “normalized sample” is one in which the polynucleotide constituents containing the sub-ROI are present at known molar ratios, which can be equimolar or non-equimolar. The relative amount/concentration of the different polynucleotide constituents in the normalized sample is determined by the user. For example, when sequencing of the normalized sample is desired, a user would take into consideration the sequencing chemistry to be used and balance the different amplification products to achieve a uniform representation (or number of reads) in the different sub-ROI-containing polynucleotides, rather that just have an equivalent amount of each (i.e., basing the normalized sample on the number of polynucleotides containing each ROI rather than their mass quantity). This normalized sample can then be subjected to subsequent process or analysis (e.g., sequence analysis; step 310).

As indicated in FIG. 3, one or more additional process steps 312 can be included at one or more places in the workflow (e.g., a variant isolation step).

It is also noted that in certain embodiments, multiple different reduced complexity samples can be generated in step 300 of the workflow, each being subjected to one or more different sub-ROI specific amplification reactions that are employed to produce the normalized sample.

### Kits and Systems

Also provided by the subject invention are kits and systems for practicing the subject methods, as described above, such components configured to add adapter domains or sequences to nucleic acids of interest and regents for performing any steps in the ROI extraction and/or normalization processes described herein (e.g., adapters, restriction enzymes, nucleotides, polymerases, primers, exonucleases, etc.). The various components of the kits may be present in separate containers or certain compatible components may be precombined into a single container, as desired.

The subject systems and kits may also include one or more other reagents for preparing or processing a polynucleotides according to the subject methods. The reagents may include one or more matrices, solvents, sample preparation reagents, buffers, desalting reagents, enzymatic reagents, denaturing reagents, where calibration standards such as positive and negative controls may be provided as well. As such, the kits may include one or more containers such as vials or bottles, with each container containing a separate component for carrying out a sample processing or preparing step and/or for carrying out one or more steps for producing a normalized sample according to the present invention.

In addition to above-mentioned components, the subject kits typically further include instructions for using the components of the kit to practice the subject methods, e.g., to prepare nucleic acid samples for perform the mutation process according to aspects of the subject methods. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the interne, are provided. An example of this embodiment is a kit that includes a web address where the instructions can be viewed and/or from which the instructions can be downloaded. As with the instructions, this means for obtaining the instructions is recorded on a suitable substrate.

In addition to the subject database, programming and instructions, the kits may also include one or more control samples and reagents, e.g., two or more control samples for use in testing the kit.

### Utility

The normalization process described herein provides significant advantages in numerous applications.

For example, the processes herein described allow one to analyze the sequence of multiple sub-ROI from multiple samples in a single sequencing reaction without losing low-copy number species (in the starting sample or amplified intermediates) as well as reducing the overrepresentation of high-copy number species. Thus, the normalization processes described herein, e.g., from ROI-enriched or non-enriched polynucleotide samples, allow more efficient use of sequencing bandwidth, providing increased sequence coverage per run. In embodiments that employ multiplexed samples comprising polynucleotides coded with MID tags, sequences obtained can be correlated with their source sample (e.g., which individual has a specific sub-ROI sequence). This can be applied to a wide variety of applications, including identifying sequence variants and the individuals possessing such variants in a population and/or relating a specific sequence variation (or variations) to genetic predisposition to a phenotype in the population under study. Such populations occur in scientific research where the aim is to understand the link between phenotype and gene sequence as well as in clinical trials where one wishes to understand links between gene sequence of disease or between gene sequence and efficacy (or toxicity) of potential therapies and drug treatments. Similar applications of course exist in plants, animals, microorganisms and viruses, etc.

As currently practiced, extractions of ROI (e.g., as done using oligonucleotide probes on microarrays or in solution) generally rely on only one genomic region specific oligonucleotide sequence. According to certain aspects of the present invention, at least two independent sequence specific binding events at independent genomic locations are employed. For example, a first sequence specific binding event can occur in the initial ROI enrichment (or pull-out reaction) and a second sequence specific binding event can occur in the binding of the primer (or primers) used for the sub-region amplification (e.g., one of the primers used in the PCR sub-ROI amplification). Having two independent sequence-specific binding events in these embodiments greatly increase the specificity of the ROI (and sub-ROI) fragment enrichment/isolated process, thereby streamlining the analysis of these fragments (e.g., by reducing the number of fragments to be processed/sequenced).

Moreover, normalization by mixing (or ‘blending’) the individual amplification reactions means that the representation of the individual sequence regions which comprise the ROI (or sub-ROI) can be carefully controlled. This results in more uniform coverage of the regions of interest, e.g., when analyzing a sub-ROI from multiple different sources in a multiplexed sample. If representations are significantly unequal, as can be the case in non-normalized samples, then one must have sufficient coverage for the least represented ROI. However, this results in gross over-representation of the more frequently occurring fragments, greatly increasing sequencing costs and/or time required for analysis (see Examples section below, which demonstrates how ROI extraction and normalization as described herein leads to much more even fragment representation in a ROI-enriched sample). It is noted again, however, that a normalized sample does not necessarily contain substantially equal amounts (or numbers) of each sub-ROI polynucleotide, as in certain embodiments a user may want different amounts of one or more sub-ROI polynucleotide relative to other sub-ROI polynucleotides in the sample. For example, enrichment of a desired genomic region might also result in enrichment of a similar genomic region that shares significant homology, e.g., due to a genomic duplication. In this case, inclusion of a larger amount of this sub-ROI polynucleotide relative to other sub-ROI polynucleotides in the sample might be beneficial. No limitation in this regard is intended.

The ROI extraction/normalization processes described herein allow one to determine whether the ROI enriched polynucleotide sample being submitted to a sequencing process has a sufficient fragment representation, amount, and quality. This is in contrast to current approaches which require one to complete the entire workflow (including sequencing/analysis) to receive feedback on whether all the intermediate steps of the workflow are generating a sample of optimal quality. Thus, aspects of the subject invention provide a sample quality control step immediately prior to analysis (e.g., sequencing).

As noted above, aspects of the subject ROI extraction/normalization processes described herein are suited to the analysis of multiplexed samples, where the origin of each polynucleotide in the multiplexed sample can be determined based on the identity of an attached MID tag (or tags). In such aspects, the multiplexed polynucleotides are subjected to ROI extraction and sub-ROI amplification/quantitation/normalization simultaneously. For example, a multiplex sample containing MID-tagged polynucleotides derived from 1,000 different individuals can be subjected to a single ROI enrichment reaction (e.g., in a single tube) followed by amplification of ten different sub-ROI in ten different reactions (e.g., in ten different tubes) which are then quantitated and mixed into a normalized sample having known relative amounts of each multiplexed sub-ROI.

This is in contrast to current amplification/normalization schemes in which the polynucleotides from each different individual (or source) are processed for ROI extraction and/or amplification independently. Processing 1,000 samples in this manner requires significantly more individual reactions to be performed as compared to the multiplex embodiments described above. For example, if 1,000 different individuals are to be assayed, for each ROI or sub-ROI of interest at least 1,000 different ROI extraction and amplification reactions would need to be performed followed by at least 1,000 different quantitation analyses prior to production of the normalized sample. This is a significantly more burdensome process than the multiplexed embodiments described herein.

The above description is provided merely as exemplary of the utility of the subject invention, and is not in any way intended to limit the applicability of the invention to other mutation/variant identification endeavors.

### EXAMPLES

### Example I

### Comparison of Normalized to Non-Normalized Sequence Analysis

### A. Non-Normalized Polynucleotide Sample Production and Sequencing

Capture probes. Capture probes were 5′-biotinylated 60-mer reverse phase cartridge purified oligonucleotides (BioSearch). The pool of 60 capture probes consisted of 2.85 nM of each probe in dH2O.

Library. The asymmetric polynucleotide library was produced as described in U.S. patent application Ser. No. 12/432,080, filed on Apr. 29, 2009, and titled “Asymmetric Adapter Library Construction” (incorporated herein by reference). The “left” adapter domain of the library includes the following elements in a 5′ to 3′ orientation: a 454A sequencing primer binding site and a MID. The “right” adapter domain includes a 454B sequencing primer binding site.

Hybridization. A 7 μL mix containing 2.5 μg mouse Cot-1 DNA (Invitrogen), 2.5 μg salmon sperm DNA (Invitrogen), 500 ng library, and 25 pmol of each blocking oligo (Table 1) was heated to 95° C. for 5 min, held at 63° C. for 5 min, and mixed with 13 μL pre-warmed (63° C.) 2× hybridization buffer (10×SSPE, 10×Denhardt's, 10 mM EDTA and 0.2% SDS) and 6 μL pre-warmed (5 min at 63° C.) pooled capture probes. After 24 hours at 63° C., the hybridization was added to 50 μL Dynabeads MyOne Streptavidin Cl (Invitrogen), that had been previously washed three times with 50 μL wash buffer (1 M NaCl, 10 mM Tris-HCl, pH 7.5, and 1 mM EDTA), resuspended in 200 μL wash buffer and pre-warmed (one hour at 43° C.). After one hour at 43° C., the beads were pulled down and washed once at 20° C. for 15 min with 0.5 mL 1×SSC/0.1% SDS, followed by three 10 min washes at 63° C. with 0.5 mL pre-warmed (63° C.) 0.1×SSC/0.1% SDS. Capture DNA was eluted from the beads by adding 50 μL 0.1 M NaOH. After 10 min at 20° C. the beads were pulled down and the supernatant transferred to a new tube containing 70 μL 1 M Tris-HCl, pH7.5. The capture DNA was then concentrated using AMPure SPRI beads (Agencourt) and resuspended in 20 μL dH₂O.

TABLE 1

| Blocking oligo sequences (5′ to 3′) | SEQ ID NO |
|---|---|
| AAGGAGAGGAGGTAATACGACTCACTATAGGGAGAG | SEQ ID NO: 1 |
| CCTCCCTCGCGCCATCAGBDHVBDTAGAATGTGGAT | |
| CACATTCTACTGAGCGGGCTGGCAAGGCTCTCCCTTT | SEQ ID NO: 2 |
| AGTGAGGGTTAATTCCTCCTCTCCTT | |
| ATCCACATTCTAHVBDHVCTGATGGCGCGAGGGAGGC | SEQ ID NO: 3 |
| TCTCCCTATAGTGAGTCGTATTACCTCCTCTCCTT | |
| AAGGAGAGGAGGAATTAACCCTCACTAAAGGGAGAG | SEQ ID NO: 4 |
| CCTTGCCAGCCCGCTCAGTAGAATGTG | |

Generic PCR amplification. 20 μL of capture material was amplified for 10 cycles in a 50 μL reaction comprising 0.3 μM each primer:

(SEQ ID NO: 5)
454A (5′-GCCTCCCTCGCGCCATCAG-3′)
and
(SEQ ID NO: 6)
454B (5′-GCCTTGCCAGCCCGCTCAG-3′);

10 μL 5× reaction buffer, 2.5 mM MgCl₂, 0.2 mM each dNTP, and 1.25 Units GoTaq Hot Start Polymerase (Promega). Cycling was 95° C. for 2 min followed by 30 cycles at 95° C. for 30 sec, 60° C. for 30 sec and 72° C. for 1 min and a final extension at 72° C. for 10 min. The PCR product was purified using AMPure SPRI beads (Agencourt) and sequenced using the GS FLX 454 Amplicon sequencing kit (Roche).

### B. Normalized Polynucleotide Sample Production and Sequencing

Capture probes. Capture probes were 5′-biotinylated 60-mer reverse phase cartridge purified oligonucleotides (BioSearch). The pool of 60 capture probes consisted of 2.85 nM of each probe in dH₂O.

Library. The asymmetric polynucleotide library was produced as described in U.S. patent application Ser. No. 12/432,080, filed on Apr. 29, 2009, and titled “Asymmetric Adapter Library Construction” (incorporated herein by reference). The “left” adapter domain of the library includes the following elements in a 5′ to 3′ orientation: a 454A sequencing primer binding site and a MID. The “right” adapter domain includes a 454B sequencing primer binding site.

Hybridization. A 7 μL mix containing 2.5 μg mouse Cot-1 DNA (Invitrogen), 2.5 μg salmon sperm DNA (Invitrogen), 500 ng library, and 25 pmol of each blocking oligo (Table 2) was heated to 95° C. for 5 min, held at 63° C. for 5 min, and mixed with 13 μL pre-warmed (63° C.) 2× hybridization buffer (10×SSPE, 10×Denhardt's, 10 mM EDTA and 0.2% SDS) and 6 μL pre-warmed (5 min at 63° C.) pooled capture probes. After 24 hours at 63° C., the hybridization was added to 50 μL Dynabeads MyOne Streptavidin C1 (Invitrogen), that had been previously washed three times with 50 μL wash buffer (1 M NaCl, 10 mM Tris-HCl, pH 7.5, and 1 mM EDTA), resuspended in 200 μL wash buffer and pre-warmed (one hour at 43° C.). After one hour at 43° C., the beads were pulled down and washed once at 20° C. for 15 min with 0.5 mL 1×SSC/0.1% SDS, followed by three 10 min washes at 63° C. with 0.5 mL pre-warmed (63° C.) 0.1×SSC/0.1% SDS. Capture DNA was eluted from the beads by adding 50 μL 0.1 M NaOH. After 10 min at 20° C. the beads were pulled down and the supernatant transferred to a new tube containing 70 μL 1 M Tris-HCl, pH7.5. The capture DNA from four separate hybridization reactions were combined, concentrated using AMPure SPRI beads (Agencourt) and resuspended in 10 μL dH₂O.

TABLE 2

| Blocking oligo sequences (5′ to 3′) | SEQ ID NO |
|---|---|
| ATGCACATTCTA | SEQ ID NO: 7 |
| CTGAGTCGGAGACACGCAGGGATGAGATGG | SEQ ID NO: 8 |
| CCTATCCCCTGTGTGCCTTGGCAGTCTCAGTAGAA | SEQ ID NO: 9 |
| TGTG | |
| TAGAATGTGCAT | SEQ ID NO: 10 |
| CCATCTCATCCCTGCGTGTCTCCGACTCAG | SEQ ID NO: 11 |
| CACATTCTACTGAGACTGCCAAGGCACACAGGGG | SEQ ID NO: 12 |
| ATAGG | |

Generic PCR amplification. 10 μL of capture material was amplified for 10 cycles in a 50 μL reaction comprising 0.3 μM each primer:

(SEQ ID NO: 13)
Ti-454A (5′-CCATCTCATCCCTGCGTGTCTCCGACTCAG-3′)
and
(SEQ ID NO: 14)
Ti-454B (5′-CCTATCCCCTGTGTGCCTTGGCAGTCTCAG-3′);

10 μL 5× reaction buffer, 2.5 mM MgCl₂, 0.2 mM each dNTP, and 1.25 Units GoTaq Hot Start Polymerase (Promega). Cycling was 95° C. for 2 min followed by 10 cycles at 95° C. for 30 sec, 60° C. for 30 sec and 72° C. for 3 min and a final extension at 72° C. for 10 min. Four separate PCR reactions were purified using AMPure SPRI beads (Agencourt) and resuspended in 1260 μL dH₂O.

Secondary PCR amplification. 2.5 μL of PCR product was amplified for 35 cycles in a 50 μL touchdown PCR reaction comprising 0.152 μM each primer (Ti-454A and fragment specific primer), 10 μL 5× reaction buffer, 2.5 mM MgCl₂, 0.2 mM each dNTP, and 0.25 Units GoTaq Hot Start Polymerase (Promega). Cycling was 95° C. for 2 min followed by 4 cycles at 95° C. for 1 mM, 75° C. for 30 sec (−1° C. per cycle) and 75° C. for 40 sec (−1° C. per cycle), then 11 cycles at 95° C. for 1 min, 71° C. for 30 sec (−1° C. per cycle) and 72° C. for 40 sec, then 15 cycles at 95° C. for 1 min, 60° C. for 30 sec and 72° C. for 40 sec, and a final extension at 72° C. for 10 mM. Amplicons were quantitated using the DNA 1000 Kit (Agilent 2100 Bioanalyzer), pooled in equimolar ratios, purified using AMPure SPRI beads (Agencourt) and sequenced using the GS FLX Titanium Shotgun sequencing kit (Roche).

### Results

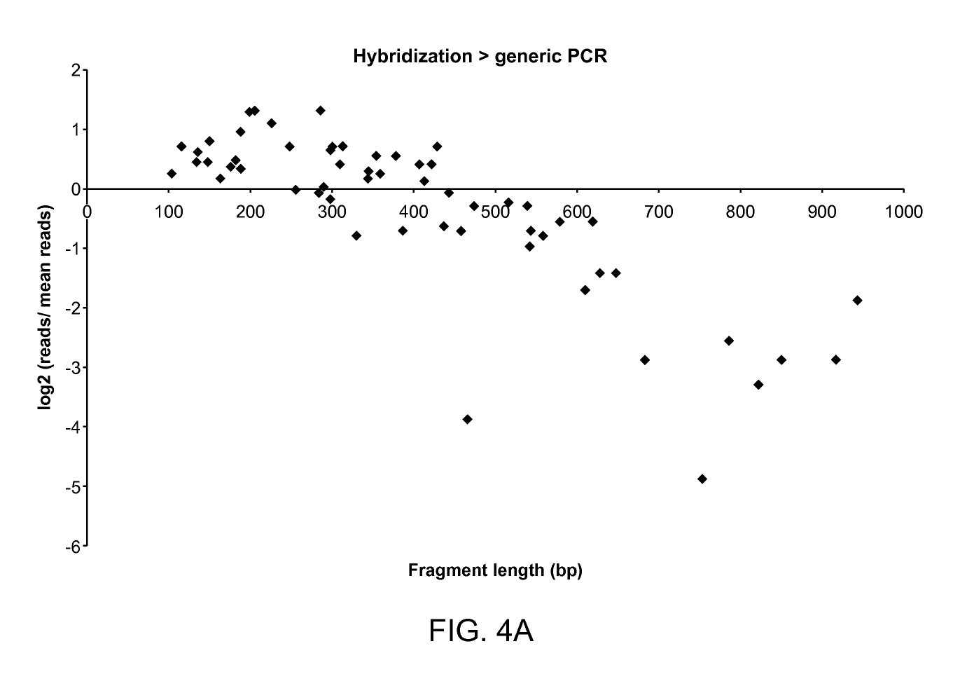

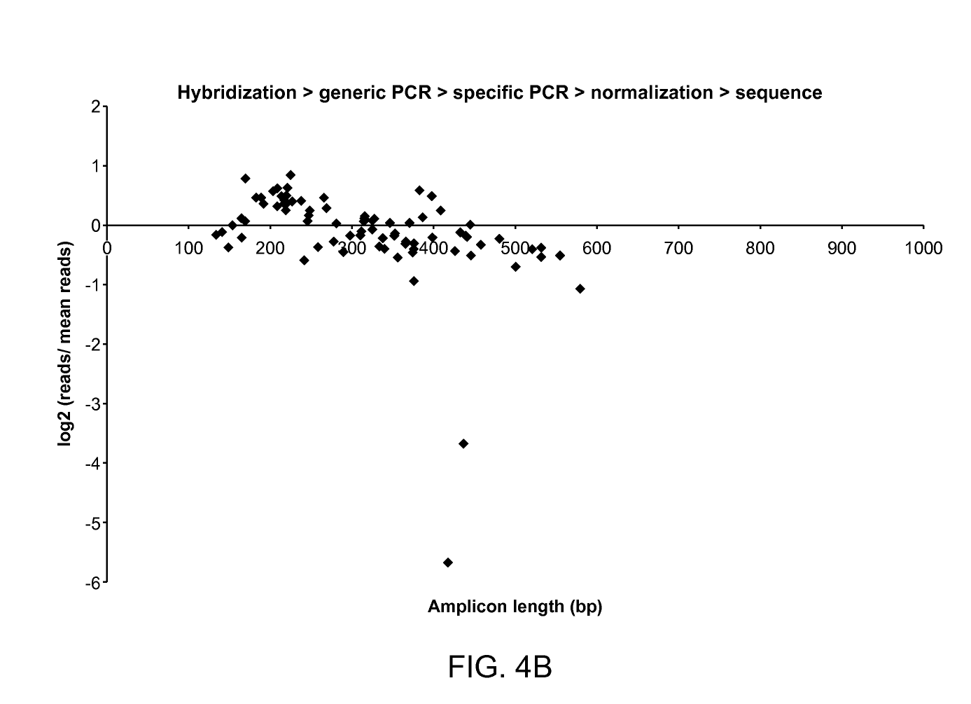

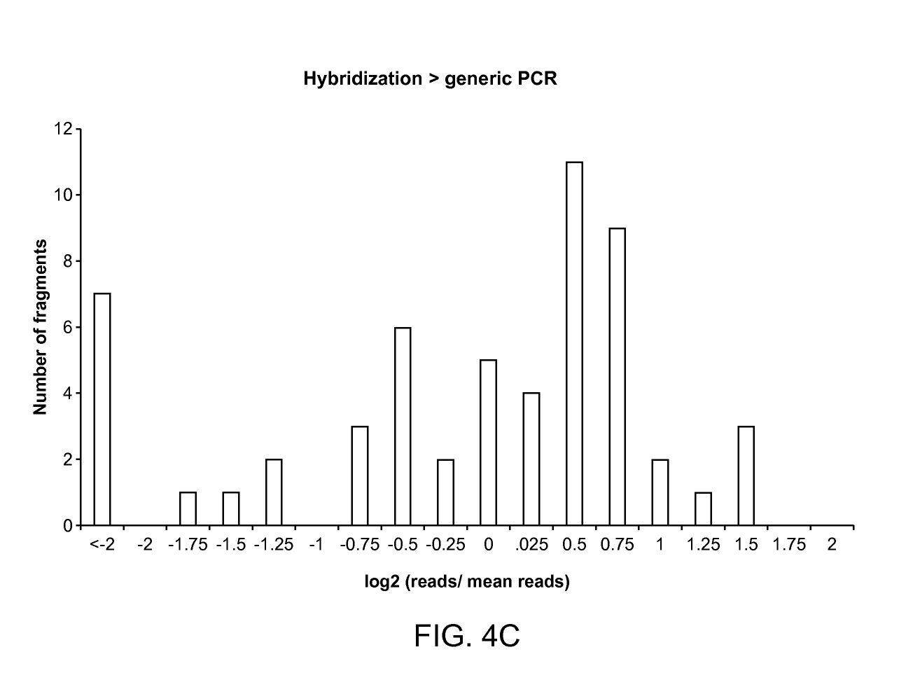

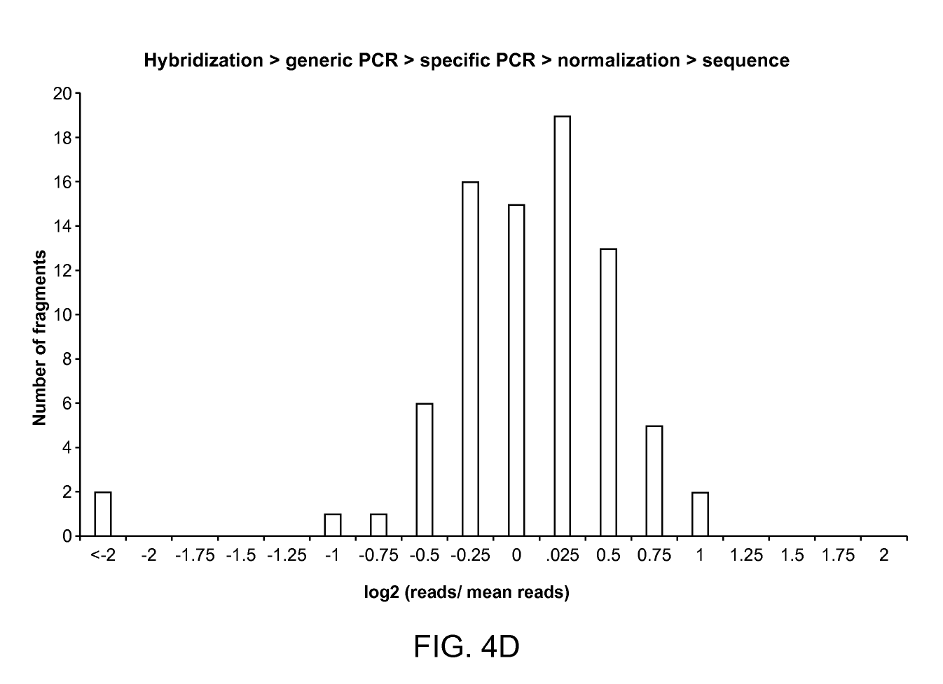

FIGS. 4A and 4B show results of sequencing the non-normalized and normalized samples, respectively. The dot plots show the number of reads for a specific polynucleotide fragment (based on its sequence) divided by the average number of reads per fragment (Y axis—plotted as a Log(base2) ratio). The dot plots are listed as a function of fragment length (X-axis).

FIGS. 4 C and 4D show the same data (for non-normalized and normalized samples, respectively) displayed in histograms displaying the numbers of fragments (Y-axis) with reads above or below the average number of reads (X-axis).

Comparing FIG. 4A to 4B and 4C to 4D, one can see that the normalized samples have a much narrower distribution of fragment analysis with regard to the number of reads for each fragment compared to the mean number of reads. This confirms the utility of the ROI/normalization workflow in reducing the sequence burden for analysing sub-sequences from one or more ROI.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method of producing a mixture of polynucleotides at known molar ratios comprising;
a) performing at least two independent amplification reactions on one or more polynucleotide sample to produce at least two amplified samples, wherein the amplified polynucleotides (amplicons) in each amplified sample comprise a different sub-region of one or more region of interest (ROI);
b) determining the concentration or amount of the amplicons in the at least two amplified samples; and
c) mixing amplicons from the at least two amplified samples based on their respective determined concentration or amount, thereby producing a mixture of polynucleotides at known molar ratios.

2. The method of claim 1, wherein the polynucleotide sample comprises polynucleotides from multiple different sources.

3. The method of claim 2, wherein the polynucleotides from the multiple different sources are each tagged with a multiplex identifier (MID) that corresponds to its source.

4. The method of claim 1, wherein the determining step comprises one or more of: quantitative PCR (QPCR), fluorescent oligonucleotide primers, capillary electrophoresis, gel-electrophoresis, spectrophotometry, nucleic acid specific dye binding.

5. The method of claim 1, wherein the polynucleotides in the polynucleotide sample comprise adapter domains, wherein the adapter domains comprise one or more of: an MID tag, a primer binding site, a reflex site, a complement of a reflex site, and a unique restriction enzyme site.

6. The method of claim 1, wherein the method further comprises performing a generic amplification reaction on the one or more polynucleotide sample before step (a).

7. The method of claim 1, wherein the method further comprises performing a generic amplification reaction on the at least two amplified samples.

8. The method of claim 1, wherein the polynucleotide sample is a reduced complexity sample enriched for polynucleotides comprising the one or more ROI.

9. The method of claim 8, wherein the reduced complexity sample is produced by contacting a starting polynucleotide sample to one or more capture probe under annealing conditions and isolating polynucleotides bound to the one or more capture probe.

10. The method of claim 9, wherein the one or more capture probe comprises a binding moiety.

11. The method of claim 9, wherein the isolating step (a) further comprises performing a nucleic acid synthesis reaction using the capture probe as a nucleic acid synthesis primer, wherein the extension reaction includes one or more deoxynucleotide triphosphates having an attached binding-moiety.

12. The method of claim 9, wherein the one or more capture probe is attached to a solid support.

13. The method of claim 12, wherein the solid support is selected from: an array substrate, a bead, a pin, and a plate.

14. The method of claim 1, wherein the amplicons in step (a) comprise a reflex site and its complement, wherein the amplicons are subjected to a reflex process prior to the determining step (b).

15. The method of claim 1, wherein the method further comprises a variant isolation step.

16. The method of claim 1, wherein the mixture of polynucleotides of mixing step (c) is subjected to sequence analysis.

17. A method of producing a mixture of polynucleotides at known molar ratios comprising;
a) performing at least two independent amplification reactions on a polynucleotide sample to produce at least two amplified samples, wherein at least one of the amplification reactions comprises a reflex process, and wherein the amplified polynucleotides (amplicons) in each amplified sample comprise a different sub-region of interest (sub-ROI);
b) determining the concentration or amount of the amplicons in the at least two amplified samples; and
c) mixing amplicons from the at least two amplified samples based on their respective determined concentration or amount, thereby producing a mixture of polynucleotides at known molar ratios.

18. The method of claim 17, wherein the polynucleotide sample comprises polynucleotides from multiple different sources, and wherein the polynucleotides from the multiple different sources are each tagged with a multiplex identifier (MID) that corresponds to its source.
